(19) United States
(12) Patent Application Publication
(10) Pub. No.: US 2013/0268299 A1
(43) Pub. Date: Oct. 10, 2013

(54) ASSISTED REPRODUCTIVE TECHNOLOGY INSURANCE

(71) Applicant: Allison Dawn Meier, Houston, TX (US)

(72) Inventor: Allison Dawn Meier, Houston, TX (US)

(21) Appl. No.: 13/858,000

(22) Filed: Apr. 6, 2013

Related U.S. Application Data
(60) Provisional application No. 61/621,160, filed on Apr. 6, 2012.

(51) Int. Cl. G06Q 40/08

(52) U.S. Cl. CPC G06Q 40/08
USPC 705/4

(57) ABSTRACT

A computerized method is used for generating financial plans for the cost of infertility treatment. Further, the financial plans contemplate reimbursement for of the cost of unsuccessful infertility treatments.

### FIELD

The disclosure relates to certain insurance procedures, methodology and implementation. More specifically, the procedures and methodology relate to insurance or reimbursement policies which compensate a policyholder for unsuccessful infertility services and assisted reproduction procedures.

### BACKGROUND

Millions of women of childbearing age have problems conceiving a child. A 2002 national survey indicated that in the United States alone, there were 62 million women of reproductive age. However, that same year, 2% or 1.2 million women were reported to have had infertility related medical appointments within the previous year. An additional 10% were reported to have received infertility treatment at some time in their life.

The World Health Organization task force on Diagnosis and Treatment of Infertility determined in developed countries, diseases that contributed to infertility were attributed to the female partner in 37% of couples, to the male partner in 8% of couples, and to both partners in 35% of couples. Five percent of the couples had no identifiable cause of infertility (i.e., unexplained infertility).

The causes of female infertility Diseases in females most often identified included: ovulatory disorder (25%), pelvic adhesions (12%), tubal occlusion (11%) other tubal abnormalities (11%), hyperprolactinemia (7%), endometriosis (15%) and no identifiable diseases (20%). Decisions by people in the reproductive population to defer childbearing due to careers and other lifestyle factors are also increasing the numbers of infertile couples.

The most common causes of male infertility include abnormal sperm production or function, impaired delivery of sperm, general health and lifestyle issues, and overexposure to certain environmental elements. Sperm must be properly shaped and able to move rapidly and accurately toward the egg for fertilization to occur. If the shape and structure (morphology) of the sperm are abnormal or the movement (motility) is impaired, sperm may not be able to reach or penetrate the egg. Normal sperm concentration is greater than or equal to 20 million sperm per milliliter of semen. A count of 10 million or fewer sperm per milliliter of semen indicates low sperm concentration (subfertility). A count of 40 million sperm or higher per milliliter of semen indicates increased fertility. Complete failure of the testicles to produce sperm is rare, affecting very few infertile men. A varicocele is a varicose vein in the scrotum that may prevent normal cooling of the testicle, leading to reduced sperm count and motility. Undescended testicle occurs when one or both testicles fail to descend from the abdomen into the scrotum during fetal development. Because the testicles are exposed to the higher internal body temperature, compared with the temperature in the scrotum, sperm production may be affected. Testosterone deficiency (male hypogonadism) infertility can result from disorders of the testicles themselves, or an abnormality affecting the hypothalamus or pituitary gland in the brain that produces the hormones that control the testicles. In the genetic defect Klinefelter's syndrome, a man has two X chromosomes and one Y chromosome instead of one X and one Y. This causes abnormal development of the testicles, resulting in low or absent sperm production and possibly low testosterone. Infection may temporarily affect sperm motility. Repeated bouts of sexually transmitted diseases (STDs), such as chlamydia and gonorrhea, are most often associated with male infertility. These infections can cause scarring and block sperm passage. If mumps, a viral infection usually affecting young children, occurs after puberty, inflammation of the testicles can impair sperm production. Inflammation of the prostate (prostatitis), urethra or epididymis also may alter sperm motility. Other factors in male infertility include sexual issues such as erectile dysfunction, retrograde ejaculation, anti-sperm antibodies, emotional stress, obesity, cancer, alcohol and drugs and the like.

Infertility services often include medical tests to diagnose infertility, medical advice and treatments to help a woman become pregnant and services other than routine prenatal care to prevent miscarriage. Assisted reproductive technology includes artificial insemination and all fertility treatments in which both eggs and sperm are handled by removing eggs from a woman's ovaries, combining them with sperm in a laboratory setting and returning them to the woman's body or donating them to another woman.

Assisted reproductive technology procedures performed in the United States have increased from approximately 85,000 procedures in 1999 to approximately 150,000 procedures by 2009 according to the Centers for Disease Control. Likewise, live births after assisted reproductive technology procedures in 2009 were over two times higher than in 1999, with 31.4% of all procedures now performed resulting in a live birth. Of the various types of assisted reproductive technology, approximately 99% of the procedures in the United States are in vitro fertilization. Other types include GIFT (gamete intrafallopian transfer) and ZIFT (zygote intrafallopian transfer), or a combination thereof.

Typically in an assisted reproductive technology cycle, a woman will take certain drugs such as clomiphene, on day 1 through 10 of her cycle with egg retrieval on the tenth day. In vitro fertilization will typically take place between day 10 and 15 with transfer to the uterus following soon after. Pregnancy will generally be achieved between day 23 and 27 with a live birth between approximately day 266 to day 276.

Factors influencing assisted reproductive technology success include, but are not limited to: age, previous infertility diagnosis, history of previous births, previous miscarriages, previous assisted reproductive technology procedures, number of embryos transferred, type of procedure, the clinic used, smoking use and drinking use.

In the United States, according to a Centers for Disease Control report from 2009, of all assisted reproductive technology used, 39.9% of the procedures are performed on women under 35 years of age. 20.4% are performed on women between the ages of 35-37. 20.5% are performed on women ages 38-40. 9.8% are performed on women ages 41-42.6% are performed on women ages 43-44 and only 4.6% of the procedures are performed on women over 44 years of age. A woman's age is the most important factor affecting the chances of a live birth when her own eggs are used. Among women in their 20s, percentages of assisted reproductive technology procedures resulting in pregnancies and live births were relatively stable; however percentages decline steadily from among women in their mid-30s onward.

In all age groups, women who had a previous live birth were more or equally likely to have a successful assisted reproductive technology procedure and women who had had a previous miscarriage were about as likely to have a live birth from assisted reproductive technology as women who had never been pregnant. However, in most age groups, percentages of assisted reproductive technology procedures that resulted in live births were lower for women who had previously undergone unsuccessful assisted reproductive technology procedures. Among women with previous births, percentages of ART procedures that resulted in live births among women who did not undergo a previous ART procedure were comparable to percentages among women who had undergone previous ART cycle.

45% of all women who underwent an assisted reproductive technology procedure in 2009 underwent one or more previous cycles. Thus, it is not uncommon for women to undergo multiple assisted reproductive technology procedures.

Other statistics available to aid in the underwriting process include the percentage of procedures resulting in a live birth by age, fresh versus frozen success rates and donor success rates.

Most health insurance programs do not pay for assisted reproductive technology procedures. To date only 15 states do require some form of reimbursement or notification. However, all employers who self-insure are exempt from these laws.

Currently, no individual insurance or reimbursement policy is available that provides partial or full financial reimbursement if no live birth is achieved. While there are programs that guarantee a live birth or the patient's money back, such programs are only contracted with select doctors, require an expensive upfront investment of all potential attempts paid in full, and do not cover costs of pre-screening tests and medications, medical procedures, travel expenses or a combination thereof.

The average cost of one in vitro fertilization treatment is over $8,000 in 2012 dollars. Broken down, the total average cost of one in vitro fertilization procedure, including testing and medications in 2012 dollars includes the following: 1) physician consult and testing $1500 to $3500, 2) treatment $8,158 for fresh or $3500 for frozen embryos, and 3) medications $2500 to $4000. Thus, the total average spent is roughly $12,000 to $18,000.

What is needed is an insurance or reimbursement policy to reimburse policyholders a percentage of their financial investment of the assisted reproductive technology procedures if no live birth is achieved, allowing for choice of doctor, and reimbursement to include costs of testing, medication, medical procedures, travel expenses or a combination thereof.

### SUMMARY

Certain embodiments of the invention relate to a method of generating financial plans for an individual using a computer, the method comprising: a server hosting a web site, wherein the website contains a data entry interface, and wherein the website is connected by a network to a personal computer of an individual; and a server hosting a program, wherein the program comprises an actuarial algorithm.

In such embodiments, the method further entails the following: having the individual, using a personal computer, enter into the data entry interface of the website a list of infertility related conditions which affect the infertility of the individual; having the website transfer the infertility related conditions through the network from the personal computer of the individual to the server hosting the actuarial algorithm; having the server hosting the actuarial algorithm generate an infertility risk factor; having the server use the infertility risk factor to generate one or more reimbursement options for infertility treatment having an insurance premium; and having the individual select one reimbursement option with a premium.

In further embodiments, the website having a data entry interface has a payment interface. In such embodiments the individual pays for the premium to activate the reimbursement option for infertility treatment. Regarding payment, the payment is made through the website by an individual entering a credit card number, a debit card number or a bank account and routing number into the payment interface. Alternatively, the payment is sent to an operator of the servers by mail, in person or by currier.

In further embodiments, the server hosting the website and the server hosting the program are the same server. Alternatively, the server hosting the website and the server hosting the program are different servers.

In the embodiments of the invention relating to infertility, the infertility related condition or conditions is any infertility related condition or conditions. In more specific embodiments, the infertility related conditions include, but are not limited to: age of the individual, infertility diagnosis, body mass index of the individual, previous pregnancies by the individual, previous miscarriages by the individual, previous ART cycles by the individual and the results of those cycles, type of ART procedure, previous abortions, smoking use, drinking use, the clinic to be used for infertility treatment, whether the embryos will be fresh or frozen, whether donor eggs will be used, male infertility factors, and whether the individual's mother was given diethylstilbestrol during pregnancy or a combination thereof.

In embodiments related to reimbursement of infertility treatment, it is contemplated that the individual will pay for each cycle of infertility treatment. Subsequently, the individual is reimbursed a percentage of the cost of cycles of unsuccessful infertility treatment. In such cases, the percentage is from 0.1% to 100% of the cost of the cycle or cycles. The reimbursement takes place after each unsuccessful cycle or after all unsuccessful cycles. A successful cycle is defined as: zygote formation, embryo implantation, pregnancy through the first trimester, pregnancy through the second trimester, a live birth or a combination thereof.

### BRIEF DESCRIPTION OF THE DRAWINGS

FIG. 1 illustrates an assisted reproductive technology reimbursement insurance method.

FIG. 2 illustrates one embodiment computer implemented system for carrying out the insurance method.

### DETAILED DESCRIPTION

While a few states do have provisions for insurance providers to cover some types of infertility treatment, in general the limited and deficient benefits are exhausted in a short time and have restrictions and conditions attached. Currently, people who do not have coverage for infertility treatments and cannot afford to pay without assistance must apply for loans with very high interest rates, or take out home equity loans to obtain funds to pay for infertility treatments. Not only is the high cost of treating infertility prohibitive, but also the prohibitive nature of the costs generate significant stress for couples seeking infertility treatments; and this stress can cause relationship problems of some frustrated couples.

Therefore, there is a need for methods and systems for providing and paying for insurance coverage of infertility treatments to reimburse the patient if a successful pregnancy or live birth is not achieved.

Furthermore, the need exists for the provision of payment options and payment plans for insurance coverage for assisted reproductive technology cycles. Additionally, the need exists for computer implemented, automated business methods and systems for providing such coverage so as to reduce the complex calculations and stress for insurance providers. Thus, certain embodiments of the invention are to provide insurance coverage for assisted reproductive technology cycles and other infertility treatments in a manner enabling individuals to pay an initial upfront cost that will ensure at a partial or full reimbursement should a successful pregnancy or live birth not take place.

In the exemplary embodiments of the present invention, the invention is described with reference to figures. While specific details of the preferred exemplary embodiments are detailed, it is to be understood that the scope of the invention is not limited by such examples.

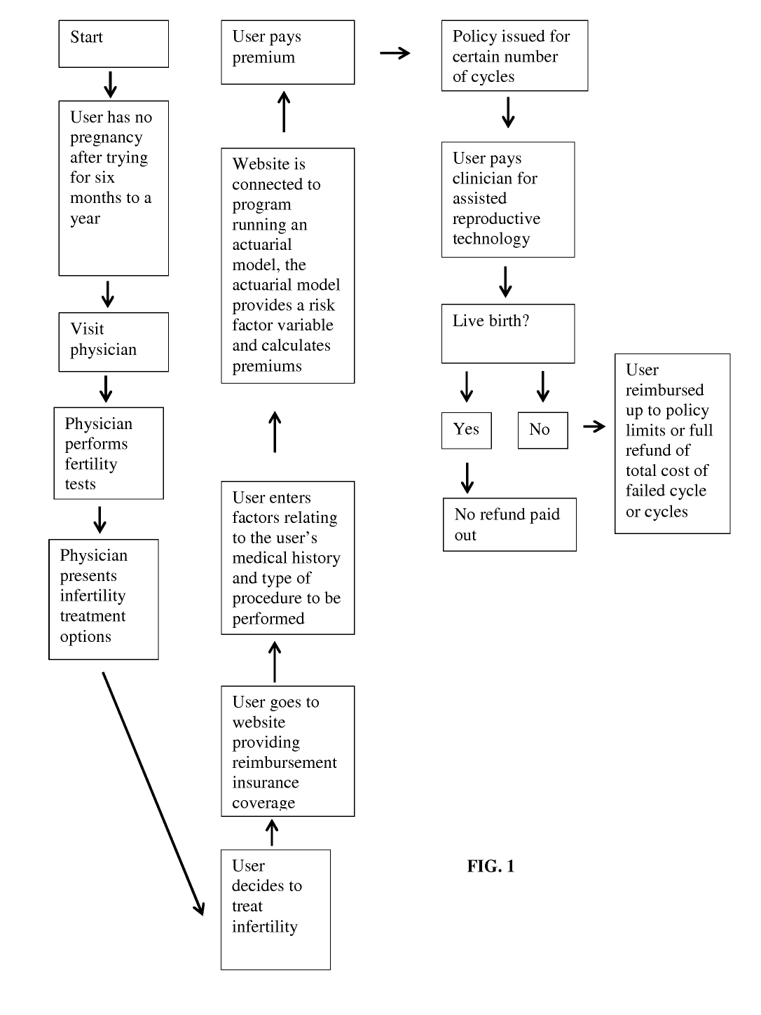

Referring to FIG. 1, in implementation, an assisted reproductive technology insurance plan with reimbursement proceeds in the following way. First, a couple or woman who has been attempting to conceive naturally with no results will visit physician where tests will be performed to determine the reason for the infertility. After the tests are performed the couple or woman if conceiving alone will again visit with the doctor where fertility treatment options will be presented. If the couple or woman does not agree to fertility treatment options then nothing more is done. If the couple or woman does agree to fertility treatment options the couple or woman will access a computer website with a graphical user interface. The computer website is hosted on a server and has a computer program tied to the graphical user interface which allows the woman or couple to enter in a number of factors. Typical factors that will be imputed into the program hosted on the server include, but are not limited to the following: 1) age of the woman, 2) body mass index of the woman, 3) previous pregnancies, 4) previous miscarriages, 5) the clinic to be used, 6) whether the embryos will be fresh or frozen, 7) whether donor eggs will be used, 8) male infertility factors 9) whether the woman's mother was given diethylstilbestrol during pregnancy, 10) previous assisted reproductive technology cycles, 11) infertility diagnosis, 12) type of ART or infertility procedure, 13) smoking use 14) drinking use and other health related issues and 15) limit of insurance desired. Other factors can also be used should they become apparent factors in the treatment of infertility.

Still further in implementation, after the woman or couple has entered the relevant factors into the computer program hosted on a server; the computer will perform an actuarial model to generate a risk factor variable. The computer program hosted on a server will then calculate one or more premiums which will allow the woman or couple to pick the limit of insurance for assisted reproductive technology or infertility treatment that is desired to be insured or reimbursed. The woman or couple will then enter a credit or debit card number or checking account information into the computer program, which will allow for payment of the upfront premium. It is contemplated herein that the actuarial model used generate a risk factor variable will be any actuarial model capable of doing so.

In further embodiments, the woman or couple interacts with a financial institution or individual, hereinafter referred to as a financier to acquire the funds for the reimbursement method. It is contemplated that the financier is a bank, a savings and loan, a brokerage firm, a corporation, a limited liability corporation, a limited liability partnership, a partnership or any other business entity. The financier is also a trustee controlling a trust or an executor of a will or any other individual. In such embodiments, the financier gives funds directly to the couple or woman, or the financier transmits the funds to the server accepting funds for the reimbursement method.

On average, implementation a single cycle of assisted reproductive technology, including medications, medical procedures and testing will cost $14,000 as of 2012 in United States dollars. The woman or couple will pay this amount to the treating physician or clinic. If the woman has a live birth after the first cycle, no payout from the reimbursement insurance will take place. If the woman fails to have a live birth after the first cycle, and has a live birth on the second cycle, no reimbursement insurance will take place. If no live birth is achieved after two or more cycles, depending on the number of cycles in the selected plan, the reimbursement insurance will pay a up to the policy limits of the costs the unsuccessful assisted reproductive technology cycles, including medications, medical procedures and travel expenses. It is possible that the percentage of reimbursement from the failed cycles is 10%, 20%, 30%, 40%, 50%, 60%, 70%, 80%, 90% or 100% or some percentage between 1% and 100%.

Regarding the reimbursement, the reimbursement in certain embodiments, takes place after each failed cycle. Alternatively, the reimbursement takes place after the totality of failed cycles has been reached. Regarding cycles resulting in a successful pregnancy, the definition in terms of reimbursement insurance is any one of a number of outcomes. For example, a successful pregnancy is a positive pregnancy test result, implantation of the embryo within the uterus, pregnancy continuing after the first trimester, pregnancy continuing after the second trimester, or a successful live birth. The definition of a successful pregnancy will naturally impact the timing of the lump sum reimbursement or the per failed cycle reimbursement, depending on the option selected by the business or individual coordinating the insurance policy.

Table 1 provides a financial overview of insurance premiums and calculations for the total market of ART cycles. This table depicts age as the premium factor, however other factors such as previous infertility diagnosis, history of previous births, previous miscarriages, previous assisted reproductive technology procedures, number of embryos transferred, type of procedure, the clinic used, smoking use and drinking use in certain embodiments is used to determine premium.

TABLE 1
National Success Rate of Cycles Resulting In
Live Birth by Age - Fresh & Frozen Embryos

| AGE (Years) | <35 | 35-37 | 38-40 |
|---|---|---|---|
| % Success after | 40.7 | 32.5 | 23.2 |
| 1 cycle/attempt | | | |
| % Success after | 64.8351 | 54.4375 | 41.0176 |
| 2 cycles/attempts | | | |
| % Success after | 79.1472143 | 69.2453125 | 54.7015168 |
| 3 cycles/attempts | | | |
| Breakeven | $7,715.53 | $11,379.23 | $16,760.44 |
| Premium at a | | | |
| $37,000 Payout | | | |
| Premium charged | $9,644.41 | $14,224.04 | $20,950.55 |
| to Consumer - 25% | | | |
| profit margin | | | |
| Total Possible | 30,233 | 15,326 | 14,691 |
| IVF First Time | | | |
| Cylces - 2010 | | | |
| Total Premium | $291,574,727.70 | $217,991,765.34 | $307,788,446.42 |
| Possible - 25% | | | |
| Margin @ | | | |
| $37,000 Payout | | | |
| Total Insurance | $233,259,782.16 | $174,393,412.27 | $246,230,757.14 |
| Payout - 25% | | | |
| Margin @ | | | |
| $37,000 Payout | | | |
| Total Revenue | $58,314,945.54 | $43,598,353.07 | $61,557,689.28 |
| Total Premium - | $7,289,368.19 | $5,449,794.13 | $7,694,711.16 |
| 2.5% of Market | | | |
| Total Insurance | $5,831,494.55 | $4,359,835.31 | $6,155,768.93 |
| Payout - | | | |
| 2.5% of Market | | | |
| Total Revenue | $1,457,873.64 | $1,089,958.83 | $1,538,942.23 |
| Breakeven cost | $208.53 | $307.55 | $452.98 |
| per $1,000 | | | |
| coverage | | | |
| Cost per $1000 | $260.66 | $384.43 | $566.23 |
| coverage at 25% | | | |
| margin | | | |
| AGE (Years) | 41-42 | 43-44 | >44 |
| % Success after | 13.6 | 6.6 | 3.9 |
| 1 cycle/attempt | | | |
| % Success after | 25.3504 | 12.7644 | 7.6479 |
| 2 cycles/attempts | | | |
| % Success after | 35.5027456 | 18.5219496 | 11.2496319 |
| 3 cycles/attempts | | | |
| Breakeven | $23,863.98 | $30,146.88 | $32,837.64 |
| Premium at a | | | |
| $37,000 Payout | | | |
| Premium charged | $29,829.98 | $37,683.60 | $41,047.05 |
| to Consumer - 25% | | | |
| profit margin | | | |
| Total Possible | 6,512 | 2,897 | 989 |
| IVF First Time | | | |
| Cylces - 2010 | | | |
| Total Premium | $194,265,598.03 | $109,181,292.32 | $40,600,617.58 |
| Possible - 25% | | | |
| Margin @ | | | |
| $37,000 Payout | | | |
| Total Insurance | $155,412,478.43 | $87,345,033.86 | $32,480,494.07 |
| Payout - 25% | | | |
| Margin @ | | | |
| $37,000 Payout | | | |
| Total Revenue | $38,853,119.61 | $21,836,258.46 | $8,120,123.52 |
| Total Premium - | $4,856,639.95 | $2,729,532.31 | $1,015,015.44 |
| 2.5% of Market | | | |
| Total Insurance | $3,885,311.96 | $2,183,625.85 | $812,012.35 |
| Payout - | | | |
| 2.5% of Market | | | |
| Total Revenue | $971,327.99 | $545,906.46 | $203,003.09 |
| Breakeven cost | $644.97 | $814.78 | $887.50 |
| per $1,000 | | | |
| coverage | | | |
| Cost per $1000 | $806.22 | $1,018.48 | $1,109.38 |
| coverage at 25% | | | |
| margin | | | |

Table 2 shows the total costs and reimbursement to the consumer purchasing the policy based on percentage of reimbursement desired and premium. As can be seen from Table 2, without any insurance, the approximate total cost of a three cycle attempt in this model is $37,000.00 United States dollars. In the case of a 75% reimbursement plan, a woman or couple would pay the $37,000.00 dollars for treatments. In the case of no live birth, the woman or couple would recover $27,750.00 of the total costs. Thus the maximum out of pocket expense for the woman or couple would be $16,483, which is the premium cost plus the 25% of $37,000.00. In the event that the woman or couple had a live birth, the maximum out of pocket expense would be $37,000.00 plus the premium cost, or $44,233.00.

TABLE 2
Average Cost for 3 Cycle Attempts = $37,000

| | Monetary | | | Maximum Out | Maximum Out of |
|---|---|---|---|---|---|
| Reimbursement | Amount | | | of Pocket Cost | Pocket Cost |
| Percentage | Reimbursed | Premium | | with Insurance | without Insurance |
| 100% | $37,000 | $9,644 | No Live | $9,644.41 | $37,000.00 |
| | | | Birth | | |
| | | | Live Birth | $46,644.41 | $37,000.00 |
| 75% | $27,750 | $7,233 | No Live | $16,483.00 | $37,000.00 |
| | | | Birth | | |
| | | | Live Birth | $44,233.00 | $37,000.00 |
| 50% | $18,500 | $4,822 | No Live | $23,322.00 | $37,000.00 |
| | | | Birth | | |
| | | | Live Birth | $41,822.00 | $37,000.00 |

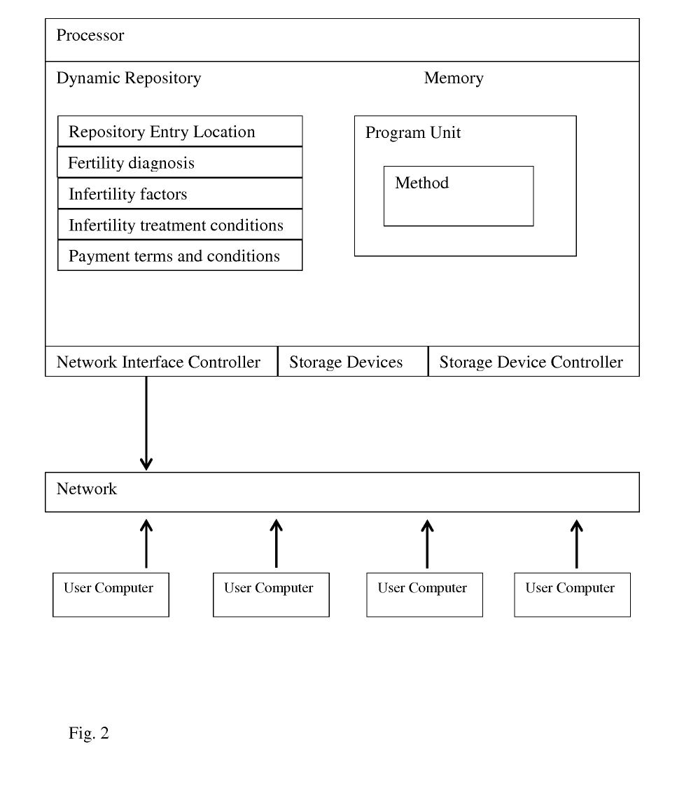

Referring to FIG. 2, the computer the method embodies a computer system and implements the various methods, procedures and operations of the method in the form of computer executable program code, computer executable and computer readable media, and other hardware, firmware and software module, network, application and interface platforms upon which the method is carried out.

Still referring to FIG. 2, the system includes a computer processor and connected to the processor are network interface controllers, input/output controllers, storage devices and input output devices such as network interface controllers, graphical user interface, an input/output controller, an output device, an input device, storage devices.

In FIG. 2, the network controller connects the processor to a network, where of client side, server side, and user network devices reside and both interact and operate communicatively over the network. These devices include a plurality of end user computers systems, such as a personal computer used by a woman or couple wishing to purchase insurance. These devices also include network database and storage systems such as a database. The network can be a wide area network communications network, including an Internet or an extranet or the network can be a local area network, including an intranet.

Referring to FIG. 2, the input the input device is at least one of a mouse, a keyboard, a touch screen, a joystick, a thumbwheel, a light pen wand, an audio microphone or an electronic, a copier system or machine, a hard copier scanner system or machine, and/or a radio frequency scanning device (RFID).

Regarding the processor, the processor includes a memory. Residing in the memory are a program unit and a dynamic repository. Residing in the dynamic repository is a plurality of database entry locations. Thus, each database entry location can hold and/or store a plurality of information and/or data including, but not limited to factors such as 1) age of the woman, 2) body mass index of the woman, 3) previous pregnancies, 4) previous miscarriages, 5) the clinic to be used, 6) whether the embryos will be fresh or frozen, 7) whether donor eggs will be used, 8) male infertility factors, 9) whether the woman's mother was given diethylstilbestrol during pregnancy 10) previous ART cycles, 11) infertility diagnosis, 12) type of assisted reproductive technology procedure (also known as ART procedure), 13) smoking use, 14) drinking use, and 15) other health related issues. Payment terms and conditions as well as contact information is also stored. These groups of information and data can be easily and programmatically accessed and exercised to provide various solutions to insurance related problems in regard to the provision of insurance coverage policies for treatable infertility conditions.

The program has computer readable and computer executable media that itself contains a plurality of computer programs, algorithms, software applications, including operations and procedures of the insurance method encoded as computer readable and computer executable program code in the form of a program product. Still further, the program can have algorithms, software applications, including operations and procedures of the insurance method involving payment methods of a premium and financing options generated by the program. In practice, the woman or couple would likely enter into the program from a personal computer, a credit card number and other necessary information needed for payment. Alternatively, the computer program allows for future payment by financing, cash, check, or other valuable items to be delivered to an insurance agent or insurance company controlling the program.

In example embodiments, the insurance method can be implemented in software, firmware or hardware or a combination of each. In certain embodiments, the insurance method is implemented in software as an executable program code which comprises an ordered listing of executable instructions for implementing logical functions and which is executed by a server.

In certain embodiments, the reimbursement insurance method is implemented in a server having a processor as a processor. The processor is a hardware device for executing software including software stored in the memory and in the program unit, including a program encoded as the reimbursement insurance method. The processor can be any custom made or commercially available, off-the-shelf processor, a central processing unit (CPU), one or more auxiliary processors, a semiconductor based microprocessor, in the form of a microchip or chip set, a macroprocessor or generally any device for executing software instructions. The memory and the dynamic repository and the storage device or devices, and the plurality of databases can include any one of or a combination of volatile memory elements, including random access memory (including RAM, DRAM, SRAM and/or SDRAM) and non-volatile memory elements including read only memory (including ROM, erasable programmable read only memory, electronically erasable programmable read only memory EEPROM, programmable read only memory PROM, and/or compact disc read only memory CD-ROM or FLASH memory) magnetic tape, disk, diskette, cartridge, cassette and/or optical memory. The memory can have an architecture where various components are situated remotely from one another, but can be accessed by the processor.

In a first exemplary embodiment, a woman or a couple enter in a website hosted connected to a server hosting the executable software. The server receives a signal from the user input device such as a personal computer, which activates and initiates the computer executable program code of the method. The method, upon activation, performs other operations from selection signals received in the processor from the input device, causing the method to be executed by the processor to perform operations and procedures including calling algorithms and applications executed to perform operations and sub operations of the method of providing one or more reimbursement insurance coverage policies for treatable infertility conditions women or couples. Thus, the processor receives automatically and electronically over the communications network a signal requesting initiation of the program code to register a woman or a couple for reimbursement insurance coverage policies for treatable infertility conditions.

1. A method of generating assistive reproductive technology and infertility treatment insurance and/or reimbursement financial plans for an individual using a computer, the method comprising:
a) a server hosting a web site, wherein the website contains a data entry interface, and wherein the website is connected by a network to a computer of an individual or organization;
b) a server hosting a program, wherein the program comprises an actuarial algorithm; and comprising the steps of:
i) having the individual, using a computer, enter into the data entry interface of the website a list of infertility and health related conditions which affects the infertility of the individual;
ii) having the website transfer the infertility and health related conditions through the network from the personal computer of the individual to the server hosting the actuarial algorithm;
iii) having the server hosting the actuarial algorithm generate an infertility risk factor;
iv) having the server use the infertility risk factor to generate one or more reimbursement options for infertility treatment having an insurance premium;
v) having the individual select reimbursement option or options with a premium.

2. The method of claim 1, wherein the server hosting the website and the server hosting the program are the same server.

3. The method of claim 1, wherein the server hosting the website and the server hosting the program are different servers

4. The method of claim 1, wherein the infertility related conditions include: age of the individual, body mass index of the individual, previous pregnancies by the individual, previous miscarriages by the individual, the clinic to be used for infertility treatment, whether the embryos will be fresh or frozen, whether donor eggs will be used, male infertility factors, previous assisted reproductive technology cycles attempted by the individual and the results of those cycles, infertility diagnosis, type of assisted reproductive technology procedure by the individual, smoking use, drinking use and whether the individual's mother was given diethylstilbestrol during pregnancy or a combination thereof.

5. The method of claim 1, wherein a reimbursement option for infertility treatment includes one, two or more cycles of infertility treatment.

6. The method of claim 5, further comprising having the individual or a financier pay the premium to activate the reimbursement option for infertility treatment.

7. The method of claim 6, wherein the data entry interface further has a payment interface.

8. The method of claim 7, wherein the individual enters a credit card number, a debit card number or a bank account and routing number into the payment interface.

9. The method of claim 1, wherein the payment is sent to an operator of the servers by mail, in person or by currier and the operator activates the reimbursement option for infertility treatment.

10. The method of claim 6, wherein the individual pays a cost for each cycle of infertility treatment.

11. The method of claim 10, wherein a successful cycle of infertility treatment is defined as: zygote formation, embryo implantation, pregnancy through the first trimester, pregnancy through the second trimester, a live birth or a combination thereof.

12. The method of claim 11, wherein the individual is reimbursed a percentage of the cost of cycles of unsuccessful infertility treatment, including medications, medical procedures, medical testing, travel expenses or a combination thereof.

13. The method of claim 11, wherein the individual is reimbursed after each cycle of unsuccessful infertility treatment.

14. The method of claim 11, wherein the individual is reimbursed after all unsuccessful cycles of infertility treatment have taken place.
